(19) United States
(12) Patent Application Publication
(10) Pub. No.: US 2015/0040325 A1
(43) Pub. Date: Feb. 12, 2015

(54) Mattress Pad and Bed Pan Assembly

(71) Applicant: Melinda Bennett, West Point, MS (US)

(72) Inventor: Melinda Bennett, West Point, MS (US)

(21) Appl. No.: 14/445,807

(22) Filed: Jul. 29, 2014

Related U.S. Application Data
(60) Provisional application No. 61/859,506, filed on Jul. 29, 2013.

(51) Int. Cl. A61G 7/02; A47C 27/14; A47C 27/00

(52) U.S. Cl. CPC A61G 7/02; A47C 27/002; A47C 27/14
USPC 5/691; 5/695

(57) ABSTRACT

A waste collection assembly is provided, whereby urine and excrement from a bedridden patient can be collected without lifting or moving the patient, and without soiling the underlying mattress. The assembly comprises a mattress pad having an elongated layer of cushioning material and a central cavity disposed therein. The cavity is enclosed and supports a bed pan assembly therein. The bed pan assembly comprises an enclosed container, a flexible and replaceable waste collection bag, and a securement ring that secures the bag to the container. The container is disposed within the cavity, while the mattress pad covers the mattress. This allows waste to be collected without moving the patient or exposing the mattress to contaminants. Further provided is a cavity plug of cushioning material that can secure over the cavity when the bed pan assembly is not in use.

### CROSS REFERENCE TO RELATED APPLICATION

This application claims the benefit of U.S. Provisional Application No. 61/859,506 filed on Jul. 29, 2014, entitled “Cover Pad Pan.” The above identified patent application is herein incorporated by reference in its entirety to provide continuity of disclosure.

### BACKGROUND OF THE INVENTION

### Field of the Invention

The present invention relates to hospital beds and bed pans for bedridden patients. More specifically, the present invention relates to a new bedding system that integrates a waste removal assembly into the construction of the bedding such that a caregiver can collect and remove waste from the bedridden patient without deploying an independent bed pan and without lifting the patient to collect urine and excrement.

Managing excretory systems for bedridden and immobile patients is a daily task for nurses and caregivers, and one that is not without its share of difficulties. Many bedridden patients are not sufficiently mobile or limber enough to use a bed pan or commode chair by themselves, requiring hospital staff to assist the patient during these times. Other patients are not suitably healthy enough or in a condition that would allow a caregiver to move the patient to access a bed pan or commode chair. For these patients, waste and excrement removal is extremely difficult, and can turn into a source of frustration and embarrassment for the patient.

Maintaining a patient's health with respect is a difficult challenge, as the patient's daily bodily functions must be handled and removed, while maintaining a clean and dry environment for both patient comfort and maintained health. Most bed pans are independently deployed structures that are used to collect excrement and urine from a bedridden patient. The device is deployed under the patient after the patient is positioned thereover. However this procedure may be unsuitable for those with physical ailments or conditions that prevent large body movements. Alternative solutions exist in the art that relate to mattress systems with built-in bed pans; however these require specifically designed mattresses that can be expensive to purchase, and assemblies that generally employ several moving parts.

The present invention relates to a flexible waste bag support that is disposed within a mattress pad assembly. The mattress pad is securable over an existing bed mattress, which elevates the patient above the existing mattress using a thick layer of cushioning material. Centrally along the mattress pad is a cavity that is adapted to support a semi-rigid container, wherein a flexible bed pan is deployed. The flexible bed pan is preferably a flexible bag or liner with an upper opening. The upper opening is secured to the perimeter of the container via a securement ring or gasket, which maintains the bag in an open condition and prevents the bag from moving while in use and while deployed. The cavity is located in a space below the buttocks of a patient, wherein a caregiver can remove and replace the bag as necessary, and even remove the entire mattress pad for cleaning if necessary. When not in use, a cavity plug comprising a cushioning material is used to fill the cavity so the mattress pad is uniform across its upper surface. Overall, the present invention eliminates the need to lift patients to place a standard bedpan thereunder, and further minimizes the contamination of hospital mattress as a result of urine and excrement.

### DESCRIPTION OF THE PRIOR ART

Devices have been disclosed in the prior art that relate to bed pan systems and mattresses that accommodate a bed pan therein. These include devices that have been patented and published in patent application publications. These devices generally relate to complicated and expensive mattress assemblies and not to a removable mattress pad that can support a flexible bed pan. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 5,001,790 to Kuhn, which discloses a patient platform in which a bedridden patient can lay and have their waste collected within an opening in the platform. A mattress is provided over the platform, wherein the platform comprises a series of stiff carrier supports. The opening in the platform provides a communicating passageway between the patient and a bed pan placed under the platform and between the carrier supports. This assembly provides a complete bed structure that elevates the patient above a series of vertical supports, while providing an opening through which waste can be collected from patient lying in a supine position. The present invention contemplates a mattress pad and a flexible bag waste collection means disposed within an opening therethrough.

Another device is U.S. Pat. No. 5,081,721 to Stefano, which discloses an inflatable underlayment that is used to elevate a patient above a surface and provide a cavity therethrough to capture waste from a patient lying thereon. The device serves as a pneumatic lifting device in which a bed pan is placed within a cavity. Placement and subsequent removal of the bed pan can be accomplished by compressing the inflatable device to access the pan, thereby accomplishing this task without moving the patient in the process. The Stefano device is well suited for its goal of place and removing a bed pan below a patient without moving the same, however its construction diverges significantly from that of the present invention. The present invention contemplates a mattress pad having a material cushion layer and an opening therethrough to position a removable waste collector, whereby the opening can be covered when not in use and deployed without first lifting and placing standard bed pan under the patient.

U.S. Pat. No. 5,327,599 to Bradley, Jr. discloses a hospital bed with a bed pan insert, in which the bed includes a bed frame with a medial portion that allows for positioning a bed pan below a supine patient. The medial portion comprises a plate that supports the mattress thereover. The plate is slidable from the side of the bed, wherein the plate secures to the medial portion and removes the same to create an opening between the upper and lower sections of the mattress. Within the opening is placed a bed pan. Similar to the aforementioned devices, the Bradley, Jr. devices fails to contemplate a mattress pad having an opening, wherein the opening is adapted to support a flexible waste collection device such that urine and excrement from a supine patient can be collected without requiring a specific bed frame or mattress type to accomplish this task.

U.S. Pat. No. 6,725,485 to Hayes discloses a mattress system for collecting waste from a patient, wherein the mattress includes a cavity within the mattress and an expandable cushioned arranged therein. A control system operates the expandable cushion and allows an administrator to fill the cavity or deflate the same.

The cushion can be expanded to completely consume the cavity, or used to fill between a waste collection area and the mattress while collecting waste. The present invention contemplates simply a mattress pad with a cavity therein, the cavity being used to support a flexible collection bag using the rim of the cavity as support for the bag. While not in use, the present invention contemplates a replaceable cushion for placement over the cavity, whereby the mattress pad forms a continuous support for a patient lying thereon.

Finally, U.S. Pat. No. 6,000,078 to Stefano discloses a bed pan system that includes a cavity therein and a flexible bed pan that is supported within the cavity using a carrier. The carrier is in the general shape of the cavity and supports the flexible bed pan from its opening and around the outer surface thereof. The carrier includes a pair of fulcrum extensions to remove the carrier and the bed pan from the cavity. By contrast, the present invention pertains to a mattress pad having an opening therein that is adapted to support a bag-like waste container or flexible bed pan, wherein the opening is formed in the mattress pad and supports the flexible bed pan along its upper rim. The lower portion of the flexible bed pan is supported by the underlying mattress or by a surface provided along the lower portion of the opening. When not in use, a plug is provided for filling the opening with mattress cushioning, whereby the mattress forms a continuous support for a patient.

The present invention comprises a mattress pad device and bed pan system in which the mattress pad is positioned over an existing mattress and used to support a flexible bed pan bag for excrement and urine collection. Furthermore, the present invention provides a protective layer over an existing mattress to reduce mattress replacement, whereby the removable bed pan catches excrement and the pad is removable from the bed for cleaning purposes. Overall, the system facilitates the deployment of a bed pan below a supine patient without needing to move or adjust the patient.

It is submitted that the present invention is substantially divergent in design elements from the prior art, and consequently it is clear that there is a need in the art for an improvement to existing bed pan systems. In this regard the instant invention substantially fulfills these needs.

### SUMMARY OF THE INVENTION

In view of the foregoing disadvantages inherent in the known types of bed pan systems now present in the prior art, the present invention provides a new system in which a mattress pad is provided such that a user can collect waste from a supine patient with little to not movement of the patient and while protecting the underlying mattress from soiling.

It is therefore an object of the present invention to provide a new and improved bed pan system that has all of the advantages of the prior art and none of the disadvantages.

It is another object of the present invention to provide a bed pan system that comprises a mattress pad having an elongated construction for protecting the underlying mattress and for supporting a flexible bed pan centrally therealong.

Another object of the present invention is to provide a bed pan system that includes a cavity disposed within a mattress pad that is used to support a removable and replaceable bed pan device for waste collection.

Yet another object of the present invention is to provide a bed pan system that deploys a bed pan device below a supine patient without drastically altering the construction of the mattress or altering the comfort provide dot the patient lying thereon.

Another object of the present invention is to provide a bed pan system using a removable mattress pad that can be independently cleaned from the bed pan and the mattress.

Another object of the present invention is to provide a bed pan system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of the cavity, the flexible bed pan assembly, and the cavity plug that can be deployed over the cavity when the bed pan is not in use.

FIG. 2 shows an overhead view of the bed pan assembly in a working state, deployed within the mattress pad cavity.

FIG. 3 shows a view of the mattress pad of the present invention, which is affixable over an existing mattress.

FIG. 4 illustrates how the flexible bed pan assembly can be removed from the mattress pad and replaced as necessary.

### DETAILED DESCRIPTION OF THE INVENTION

Reference is made herein to the attached drawings. Like reference numerals are used throughout the drawings to depict like or similar elements of the bed pan system of the present invention. For the purposes of presenting a brief and clear description of the present invention, the preferred embodiment will be discussed as used for providing a means to collect urine and waste from a supine patient, while also providing a cover for an existing mattress. The figures are intended for representative purposes only and should not be considered to be limiting in any respect.

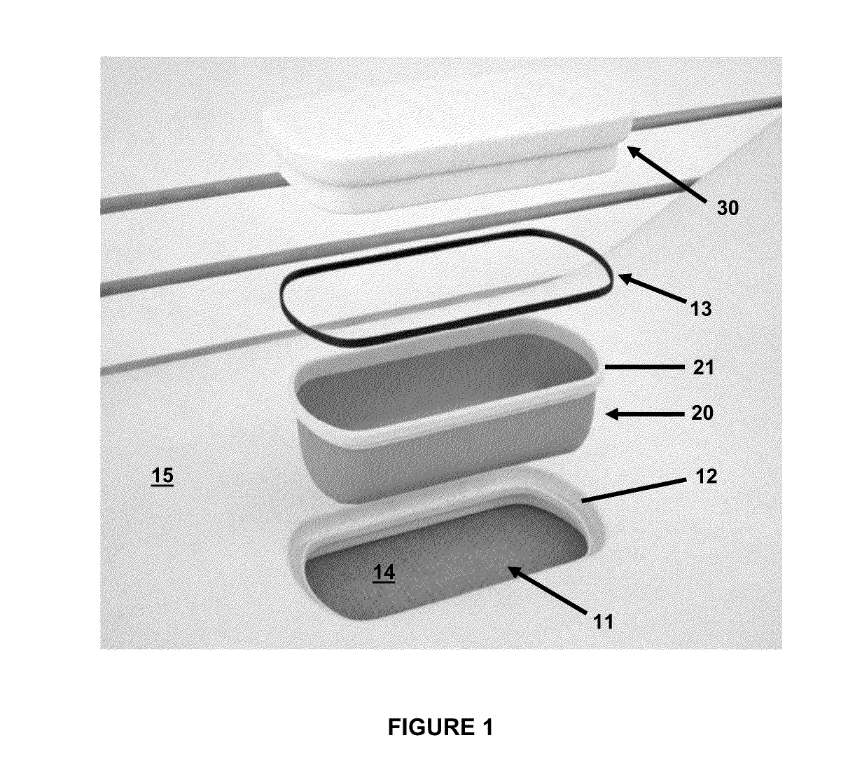

Referring now to FIG. 1, there is shown an exploded view of the bed pan system of the present invention. The bed pan system comprises a mattress pad having an elongated structure, a material thickness and a substantially flat upper surface 15. Along the central portion of the mattress pad is a cavity 11 that is preferably enclosed along its lower portion 14, whereby the sidewalls 12 of the cavity extend upwards to provide an open upper surface through which to accept a bed pan assembly therein. The lower portion 14 of the cavity is to prevent the bed pan assembly from contacting the underlying mattress when the mattress pad is positioned thereon.

The cavity 11 therefore provides a channel or open-faced enclosure within which a bed pan assembly is positioned. The bed pan assembly preferably comprises a semi-rigid container 20 that is positioned within the cavity 11 and used to support a removable, flexible waste bag (not shown) therein. The waste bag collects excrement and urine from a supine user lying on the mattress pad upper surface 15. In a preferred embodiment, container comprises an enclosed sidewall surface and an open upper bounded by a rim 21. The mouth of a flexible waste bag is folded over the rim 21 of the container 20 and secured thereto via a locking ring 13. The locking ring 13 forms a close tolerance fit with the rim 21 of the container, whereby the rim 21 of the bed pan is sandwiched therebetween. This system allows the container 20 to support a flexible waste bag that is positioned within the cavity and supported in an open position to collect waste from a user, whereby the cavity 11 is disposed along the mattress pad along a region in which a supine user's buttocks would be positioned.

The flexible waste bag is removable and replaceable without requiring the patient to move substantially during the process. Furthermore, when the cavity 11 is not being deployed as a bed pan support, a cavity plug 30 is provided that secures within the cavity 11 and covers the same. The plug 30 is a section of mattress pad cushioning material that fills the cavity and forms a continuous mattress pad upper surface 15. This allows a patient to use the mattress pad as a normal, cavity-devoid layer when a bed pan is not necessary. Furthermore, since the mattress pad is removable from the mattress, it can be removed and cleaned when necessary.

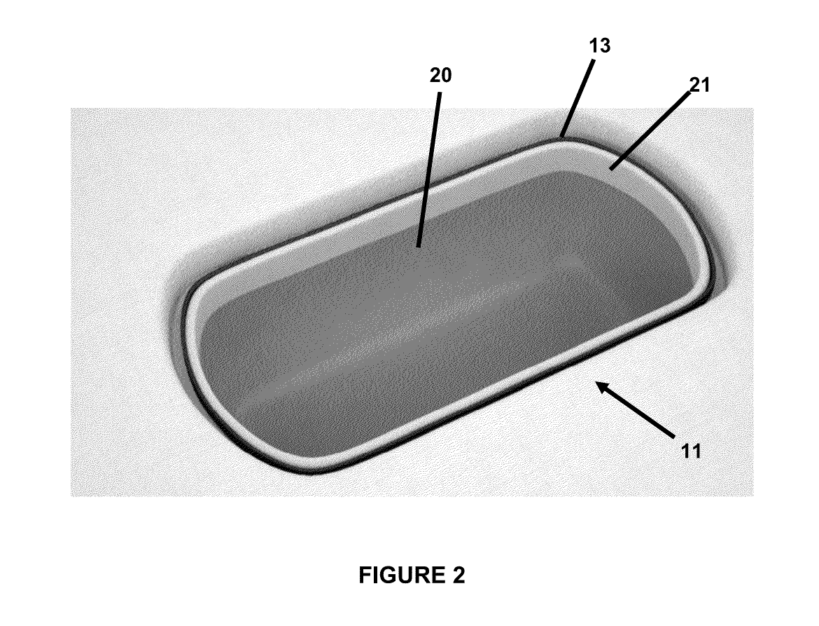

Referring now to FIG. 2, there is shown an overhead view of the bed pan assembly in a working state within the cavity 11 of the mattress pad. The bed pan assembly preferably employs a semi-rigid or rigid container 20 to support the flexible waste bag therefrom. A locking ring 13 is used to secure over the rim 21 of the container 20, and thus sandwich the flexible waste bag thereto such that the bag is positioned with its bag mouth in an open state and its interior lining the walls of the container 20. A container 20 is deployed within the cavity to prevent the bed pan assembly from compressing from a user resting thereover. The structure of the container 20 maintains its shape and thus maintains an open volume within which to capture waste from the supine patient. The waste bag is removable from the container 20 and a new bag can be replaced therein.

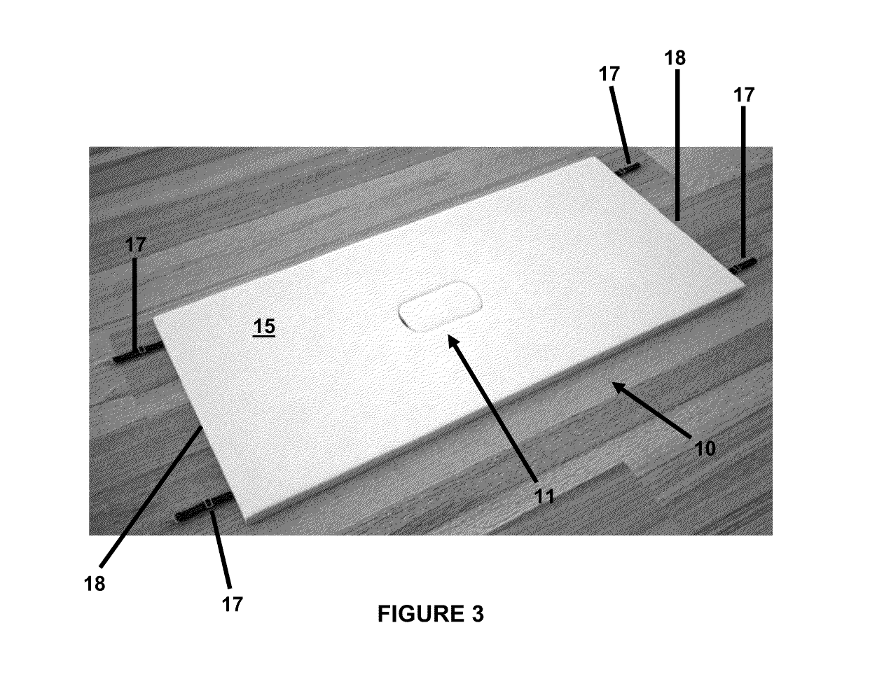

Referring now to FIG. 3, there is shown a view of the mattress pad 10 of the present invention. The mattress pad 10 comprises an elongated material layer having a thickness of cushioning material, an upper and lower end 18, sides, and an upper 15 and lower surfaces. Disposed centrally along the mattress pad 10 is the bed pan assembly cavity 11. The cavity 11 is an elongated channel that is positioned generally along the mid-portion of the pad 10 and in a location in which the buttocks of a patient would normally reside. The cushioning material of the mattress pad 10 may comprise a foam or stuffing material, or any other commonly deployed materials used in mattress pads, covers and the like.

The mattress pad 10 is a cushioning layer that is comfortable to rest upon, but also provides a thickness within which the bed pan assembly can be supported. It is contemplated that the pad 10 provides support for the bed pan assembly, and furthermore provides a layer of protection for the underlying mattress. The cavity is enclosed to prevent contamination of the mattress, and the dimensions of the pad are such that the upper surface of the mattress is entirely or substantially covered thereby. Along the ends 18 and/or sides of the pad are preferably attachment straps 17, which can be used to secure the pad to the mattress. The straps prevent relative movement of the pad with respect to the mattress, stabilizing the pad when deployed.

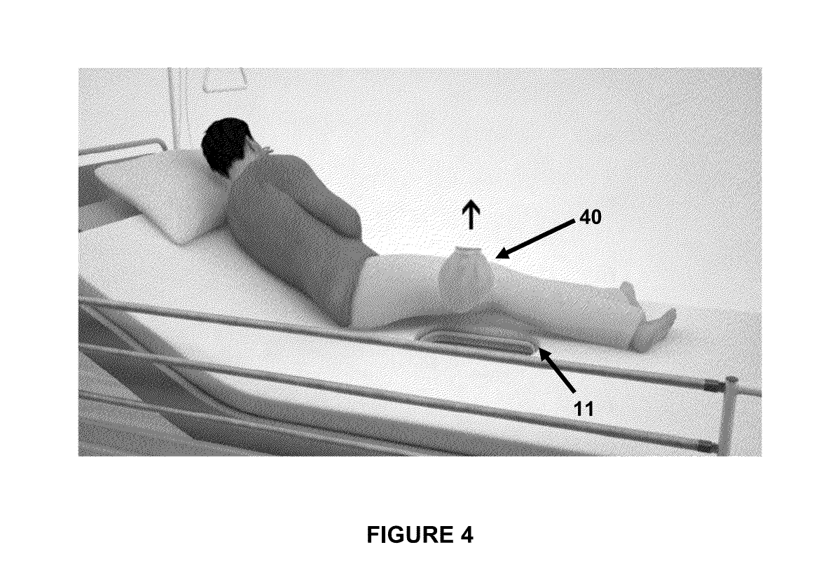

Referring finally to FIG. 4, there is shown an illustrative view of the flexible waste bag 40 being removed from the cavity 11. The flexible waste bag 40 is a plastic or similarly suitable flexible bag used to collect urine and excrement and enclose the same within its interior. The bag upper may be securable to prevent leakage or spilling, while the container can remain within the cavity 11 or be cleaned and replaced after each use.

Overall, the present invention comprises a mattress pad that is constructed from a cushioning material that is designed to cover hospital beds and mattresses. The pad includes elongated attachment straps that secure the pad to the mattress, while the central portion of the pad supports a bed pan assembly therein. The bed pan assembly comprises the container, flexible waste bag, and locking ring. The waste bag is a disposable liner with a closeable upper opening, whereby the bag is inserted into the container and stretched over the rim thereof. The locking ring fits over the rim of the container to secure the waste bag place. When patients relieve themselves, the urine and waste collects in the waste bag. The bag is removed and discarded, and the pad and container are cleaned as necessary. When the cavity is not used as a bed pan assembly support, the cavity plug may be deployed to cover the cavity. The cavity plug is a padded cover that allows the mattress pad to form a continuous layer for patient support.

To facilitate use of the pad when during the normal course of patient treatment, a specific sheet may be deployed over the pad and the mattress. The sheet may comprise a fitted or loosely attached configuration, however along its upper surface is an elongated slot or opening. This allows access to the bed pan assembly supported within the mattress pad cavity without removing the sheets. Similar to the pad and the container of the bed pan assembly, the sheet may be removed and cleaned as necessary to facilitate clean bedding materials.

Many patients who are bedridden and cannot access a bathroom rely on a bedpan. These are often used directly on top of a bed. Bedridden patients often wet their linens and/or mattress while waiting for a nurse or caregiver to place a bedpan under them. Some nurses and caregivers may leave bedpans under patients to prevent accidents, but this can be uncomfortable for patients. Other nurses and caregivers may not be able to lift patients without assistance from others, which is time consuming and inconvenient, especially with a limited staff. The present invention is directed to a novel solution to these known problems. The present invention provides a bed pan assembly that is supported by a removable a mattress pad, wherein the pad serves as a bed pan support and a mattress cover/protector. The mattress pad of the present invention collects urine and waste from bedridden patients, features a recessed cavity in the mid-section thereof, and includes an assembly that supports a disposable liner to quickly and safely discard collected waste. The present invention eliminates the need to lift patients to insert a bedpan, and also helps minimize the contamination of linens and mattresses.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A waste collection assembly, comprising:
an elongated mattress pad have a thickness of cushioning material, an upper end, a lower end, a first side, a second side, and an upper surface and a lower surface;
said elongated mattress pad having a cavity disposed through said upper surface, said cavity having an enclosed lower portion and sidewalls, said cavity further comprising an open upper;
said cavity being substantially centrally disposed along said upper surface and adapted to be positioned so as to disposed below the buttocks of a supine user over lying on said elongated mattress pad;
a bed pan assembly adapted to be supported within said cavity;
said bed pan assembly comprising a container having an enclosed lower portion and an open upper, a flexible waste collection bag, and a locking ring;
said flexible waste collection bag having flexible sidewalls with an enclosed volume and a bag opening;
said bed pan assembly further comprising an upper rim about said open upper;
said locking ring forming a close-fit tolerance with said upper rim, wherein said locking ring is adapted to sandwich said flexible waste collection bag between said locking ring and said upper rim such that said bag opening is dispose in an open state across said open upper of said container.

2) The waste collection assembly of claim 1, further comprising a removable cavity plug adapted to fill said cavity.

3) The waste collection assembly of claim 2, wherein said cavity plug comprises the same cushioning material of said elongated mattress pad.

4) The waste collection assembly of claim 2, wherein said cavity plug is adapted to fill said cavity when said bed pan assembly is not in said cavity.

5) The waste collection assembly of claim 1, wherein:
said elongated mattress pad further comprises attachment straps disposed along at least one of said upper end, lower end, first side, or second side;
said attachment straps adapted to secure said elongated mattress pad to a mattress thereunder.
